(19) United States
(12) Patent Application Publication
(10) Pub. No.: US 2010/0289447 A1
(43) Pub. Date: Nov. 18, 2010

(54) System and method for power management of energy storage devices

(76) Inventors: Eric L. Dobson, Knoxville, TN (US); Joel K. Reed, Knoxville, TN (US)

Correspondence Address: ROBERT J. LAUF, 998 W. OUTER DRIVE, OAK RIDGE, TN, 37830, US

(21) Appl. No.: 12/800,428

(22) Filed: May 14, 2010

Related U.S. Application Data
(60) Provisional application No. 61/216,424, filed on May 18, 2009.

(51) Int. Cl. H01M 10/46; H02J 7/00

(52) U.S. Cl. 320/101; 320/107; 320/137

(57) ABSTRACT

A power management system for batteries includes: a controller that controls a charger, switch matrix, and outputs, using algorithms to optimize system states based on a fuel gauge and learned conditions; a charger, which converts various inputs into charge voltage; a fuel gauge, which calculates remaining charge and battery health so the controller can effectively manage the battery and extend run-time; and a switch matrix providing management at individual cell level so that cell performance/health can be monitored. Cells can be combined dynamically in series and/or in parallel, and “bad” cells can be removed from service. A related method is also disclosed.

### CROSS-REFERENCE TO RELATED APPLICATION

This application claims the benefit of Provisional Patent Application No. 61/216,424, entitled, System and Method for Power Management of Energy Storage Devices, filed on May 18, 2009 by the present inventors, the entire disclosure of which is incorporated herein by reference.

### BACKGROUND OF THE INVENTION

1. Field of the Invention

The invention pertains to apparatus and methods for power management in a system containing energy storage devices. More particularly, the invention relates to the management and optimization of energy capture, energy storage, and energy use in stationary and mobile applications.

2. Description of Related Art

Historically, multi-cell batteries have been hard wired into either a series or a parallel configuration with the inherent advantages and limitations of each configuration: In the SERIES CONNECTION, batteries of like voltage and capacity are connected to increase the Voltage of the battery bank. The positive terminal of the first battery is connected to the negative terminal of the second battery and so on, until the desired voltage is reached. The final Voltage is the sum of all the battery voltages added together whereas the final Amp-Hour, Cranking Performance and Reserve Capacity remain unchanged. In PARALLEL CONNECTION, batteries of like voltages and capacities are connected to increase the capacity of the battery bank. The positive terminals of all batteries are connected together, or to a common conductor, and all negative terminals are connected in the same manner. The final voltage remains unchanged while the capacity of the bank is the sum of the capacities of the individual batteries of this connection; Amp-Hours, Cranking Performance and Reserve Capacity increases, whereas Voltage does not.

Some prior devices have used switches or relays to rearrange the cells for advantageous recharging structure or for short voltage and/or current “boosts”. Unfortunately, these solutions do not take full advantage of the possible cell arrangements. It will be appreciated that there are a very large number of possible configurations even with only four cells.

### OBJECTS AND ADVANTAGES

Objects of the present invention include the following: providing a system for managing and maintaining the charge in a group of energy storage devices; providing a system for optimizing power consumption in an electronic device; providing a system for optimizing battery performance in an electronic device; providing a system for managing the charge and discharge of batteries based on a learning algorithm and external conditions; providing a system for managing the charge and discharge of batteries based on geographic position; and, providing a system for evaluating the condition of individual batteries in a battery array and isolating underperforming cells from a circuit.

These and other objects and advantages of the invention will become apparent from consideration of the following specification, read in conjunction with the drawings.

### SUMMARY OF THE INVENTION

According to one aspect of the invention, a system for managing batteries comprises:

at least two battery cells capable of providing output power to one or more selected electronic devices;

a charger capable of providing a charge voltage suitable to charge the batteries;

a fuel gauge capable of reporting at least two characteristics of the batteries, selected from the following group: remaining capacity, time-to-empty, voltage, current, temperature, and remaining charge;

a switch matrix capable of providing management at the individual cell using the characteristics reported by the fuel gauge, the switch matrix further capable of combining cells dynamically in selected series and parallel arrangements;

a voltage regulator; and,

a controller that controls the charger, the switch matrix, and the outputs.

According to another aspect of the invention, a method for managing batteries comprises:

configuring a system including at least one power-consuming device, at least one battery charging device, and an array of batteries with a switch matrix capable of providing management at the individual cell level using battery characteristics reported by a fuel gauge, the switch matrix further capable of combining cells dynamically in selected series and parallel arrangements;

measuring each battery's impedance as a proxy for real, usable energy density and availability; and,

controlling the switch matrix using a controller, the controller including a learning algorithm to selectively draw, store, charge, manage, and recharge each cell in the battery array individually.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1 is a schematic diagram of one example of the present invention.

FIG. 2 is a schematic diagram of a battery “fuel gauge” according to one example of the invention.

FIG. 3 is a schematic diagram of a switch matrix according to one example of the invention.

### DETAILED DESCRIPTION OF THE INVENTION

In its most general sense, the invention comprises a system for managing an array of energy storage devices (or batteries) that are connected to some useful electronic device (or load) and also to a charging device. The charger may operate continuously, semi-continuously, or intermittently depending on the load and other performance requirements or environmental conditions. The system includes a controller and a switch matrix, which together can dynamically manage the arrangement of the batteries (series versus parallel) and the charging process to optimize performance. The system can also determine if an individual battery or cell is underperforming and effectively remove that cell from service. The controller can also manage the availability of power flow to the load, for instance going into sleep or standby mode based on various inputs (for example, geographic position as determined by GPS or other means).

As will be further described in the various examples that follow, the invention preferably contains the following components and functions: 1. A controller, preferably field programmable, controls the charger, switch matrix, and outputs. Algorithms in the controller optimize system states based on system feedback, fuel gauge, and learned condition. 2. A charger, which converts various inputs into charge voltage, is preferably voltage agile on input and output, and preferably field adaptable to stationary or mobile inputs including solar and energy harvesting. 3. A fuel gauge, which reports remaining capacity, time-to-empty, voltage, current, and temperature, calculates remaining charge under all conditions and provides complete “state-of-health” battery information so the controller can effectively manage the battery and extend run-time. 4. A switch matrix provides management at individual cell level so that cell performance/health can be monitored in and out of circuit: cells can be combined dynamically in series and/or parallel, “bad” cells can be removed from service, the number and voltage of cells can be field programmed (within hardware limits), and the number and voltage of outputs can be field programmed (within hardware limits).

According to one example of the invention, the overall approach may be summarized as follows: 1. Use learning algorithms to selectively draw, store, charge, manage, and recharge each cell in a group of a variety of energy storage devices individually. 2. Measure each device's impedance as a proxy for real, usable energy density and availability. 3. Actively manage coupling, decoupling, or switching between multiple batteries in a device to maximize energy output in an adaptive manner including learning algorithms. 4. Geographically optimize an application device's performance duty cycle, network connectivity, and availability for tracking, sensing, and reporting. 5. Ignore individual cells in the group or device based on performance as necessary such as defective cells. 6. Use learning algorithms to adaptively manage individual cells and group resources.

The following examples will illustrate more clearly the design, construction, and operation of various aspects of the invention.

### EXAMPLE

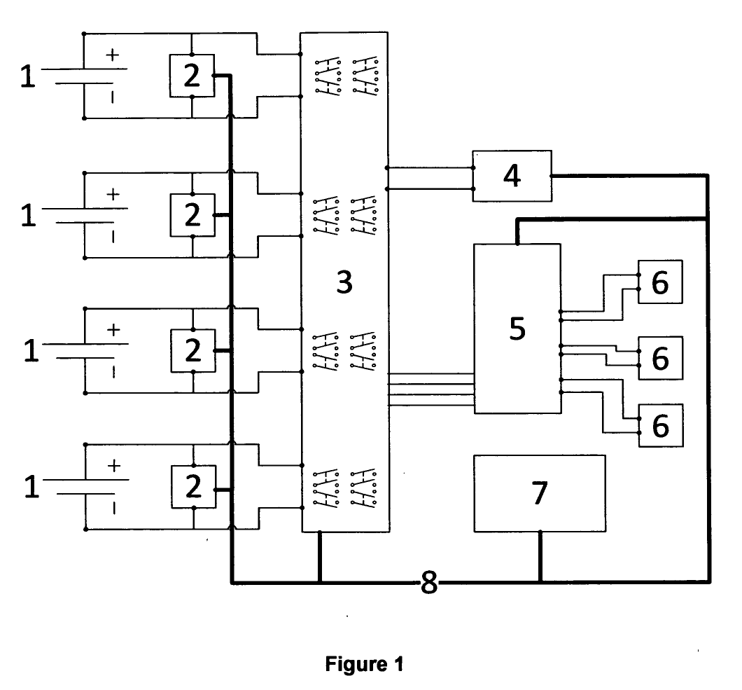

FIG. 1 shows a block diagram of one example of the invention, illustrating the relationship between any number of batteries or “cells” 1 (four of which are shown), a “fuel gauge” 2, a charger 4, a microcontroller 7 and control bus 8 (shown as a bold line in the circuit diagram), a switching device or “switch matrix” 3, voltage regulator or DC/DC convertor 5 and any number of outputs to loads 6 (three of which are shown). The batteries 1 may be of any suitable type, such as dry cells, gel cells, wet cells, thin film batteries, coin cells, etc., and may be of any size and capacity appropriate to the specific application. The power outputs are preferably DC but it will be understood that an appropriate power convertor may be included to supply AC power, as is well known in the art.

### EXAMPLE

The controller 7 may be any one of several very low power consumption, high performance integrated circuits such as the PIC24F16KA102 [Microchip Technology Inc. 2355 West Chandler Blvd., Chandler, Ariz.]. The controller uses input from the battery cell monitoring circuits 2 (battery health), the charging circuit 4 (external power availability), the DC/DC Converter(s)Noltage Regulator(s) 5 (actual voltage & current supplied to the load(s)), and the Load Profile(s) (preloaded software/firmware in controller 7) to determine the ideal configuration of the switch matrix 3 at any given instant. Voltage and current output of the Charging Circuit 4 as well as the voltage(s) from the DC/DC Converter(s)Noltage Regulator(s) 5 are also supervised by the controller. The controller algorithm “learns” how the installed battery pack responds to different operating conditions such as temperature, load, age, etc., and adjusts the series/parallel configuration of the cells in the pack accordingly. The ability to lock out under-performing cells and report this and other important information to an external information system is also preferably part of the controller's function.

A DC/DC Converter and/or Voltage Regulator is provided to serve any of several functions. The Converter/Regulator can provide conventional step-up and/or regulate-down voltage control and current limiting to the Load(s) but can also, under supervision of the Controller, turn off unneeded circuits when/where they are not needed and turn them back on in anticipation of when/where the will be needed. As used herein, the term “voltage regulator” encompasses any devices, components, or subsystems that provide any of the aforementioned functions. The Converter/Regulator is thus an important part of the system. Those skilled in the art will appreciate that most electronic sub-systems require some level of voltage regulation just to survive the variation between full charge voltage and discharged voltage. The ability to turn things completely off and back on again based on geography and other situational variables would reside in the Converter/Regulator subsystem.

### EXAMPLE

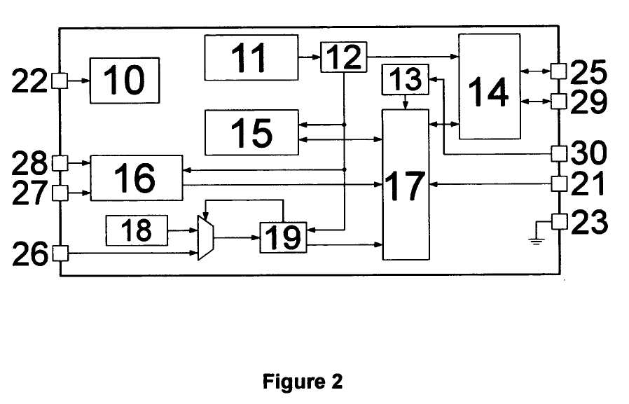

The battery cell monitoring circuit or “fuel gauge” 2 could be one of several COTS Integrated Circuits such as the TI BQ27000 [Texas Instruments, Inc., 12500 TI Boulevard, Dallas, Tex.]. The Fuel Gauge IC typically monitors a voltage drop across a small current sense resistor connected in series with the battery to determine charge and discharge activity of the battery. Compensations for battery temperature, self-discharge, and discharge rate are applied to the capacity measurements to provide available time-to-empty information across a wide range of operating conditions. Battery capacity is automatically recalibrated, or learned, in the course of a discharge cycle from full to empty. Internal registers include current, capacity, time-to-empty, state-of-charge, cell temperature and voltage, status, etc. FIG. 2 is a functional block diagram of the BQ27000, in which the index numerals designate the following features:

10. Bandgap, Reference and Bias

11. Temperature Compensated Precision Oscillator

12. Clock Generator

13. EEPROM

14. System I/O and Control

15. SCPU

16. Auto calibration and Auto compensating Coulomb Counter

17. RAM

18. Temperature Sensor

19. ADC

21. RBI Pin (Register back-up input)

22. VCC Pin(+Power In)

23. VSS Pin (Ground)

25. HDQ Pin (single-wire serial data interface)

26. BAT Pin (Monitored Battery)

27. SRN Pin (Current sense input (negative))

28. SRP Pin (Current sense input (positive))

29. GPIO Pin (General purpose input/output)

### EXAMPLE

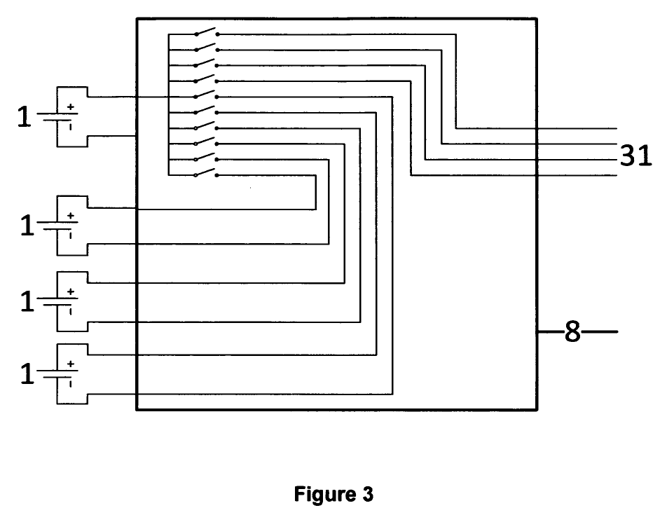

The Switch Matrix 3 is a digitally controlled array of solid state DC switches capable of routing the outputs of individual battery cells to any available output in any legitimate series/parallel configuration. Selective connections to the battery charging system and the ability to disconnect under-performing cells are also part of the Matrix facility. The switch matrix is preferably an array of discrete SMT switching transistors having a current capacity appropriate to the specific configuration and power requirements. In principle, a monolithic switch-array IC could also be used if it has the necessary power handling capacity for a particular application. In either case, the number of switches and their power rating would vary with the number of cells used and the load(s). FIG. 3 is a simplified diagram of a switch matrix in which one-eighth of the total circuit is shown. (Those skilled in the art will easily understand how the switch matrix may be expanded for the desired number of cells 1.) The control bus 8 is shown, along with several power outputs 31.

### EXAMPLE

The voltage and current output of the Charging Circuit is externally programmed by the Controller to provide the optimized recharge and/or charge maintenance for a cell, or group of cells, in the battery pack. The charger may be of any suitable type of device capable of converting an energy source into a voltage sufficient to charge the batteries. It may rely on photovoltaic power, an internal-combustion engine driven generator, electromechanical power harvesting, wind or tidal energy, or a periodic connection to an external AC or DC supply.

### EXAMPLE

The invention may be incorporated into a mobile electronic device that contains a GPS, or any other geographically aware technology (such as cell tower based positioning). In this situation, location-based data can serve as an additional input into the Controller. This location based data can be used to further optimize the battery utilization by allowing decisions based on temperature potentials, altitude, network availability, threat risk, etc. For example, if the system determines that it is presently in a “safe” area, it could shut down power consuming sensors and transmitters, going into the lowest possible power state for that environment. Conversely, a system entering a previously defined area of high risk could power up all necessary systems for rapid response.

It will therefore be appreciated by those skilled in the art that the inventive system provides a smart and situationally-aware power management system, in which inputs from any number of sensors may be included in the power management strategy through routine hardware and/or software modifications.

It will further be appreciated that the invention may be useful for the management and optimization of energy capture, energy storage, and energy use in stationary applications including, but not limited to, commercial and residential solar energy applications, commercial and industrial electrical energy applications, industrial measurement and manufacturing processes, computing applications, and communications devices. It may further be useful for the management and optimization of energy for battery operated mobile devices for tracking, monitoring, communications, network connectivity, and reporting of status and condition of cargo and cargo related containers of varying sizes, compositions, and configurations. Other applications include the management and optimization of energy consumed by battery operated mobile devices such as handheld communications devices, mobile communications devices, marine vehicle applications, automotive vehicle applications, and extra-terrestrial/space-based vehicle applications.

We claim:

1. A system for managing batteries comprising:
at least two battery cells capable of providing output power to at least one selected electronic device(s);
a charger capable of providing a charge voltage suitable to charge said batteries;
a fuel gauge capable of reporting at least two characteristics of said batteries, selected from the following group: remaining capacity, time-to-empty, voltage, current, temperature, and remaining charge;
a switch matrix capable of providing management at the individual cell using said characteristics reported by said fuel gauge, said switch matrix further capable of combining cells dynamically in selected series and parallel arrangements;
a voltage regulator; and,
a controller that controls said charger, said switch matrix, and said output(s).

2. The system of claim 1 wherein said battery cells comprise devices selected from the following group: dry cells; wet cells; gel cells; thin-film batteries; and coin cells.

3. The system of claim 1 wherein said charger derives charging energy from a source selected from the following group: photovoltaic power; mechanical energy harvesting; electrical generators; external AC power supplies; and external DC power supplies.

4. The system of claim 1 wherein said fuel gauge calculates remaining charge under present conditions.

5. The system of claim 1 wherein said switch matrix comprises an array of discrete switching transistors.

6. The system of claim 1 wherein said switch matrix comprises a monolithic switch-array integrated circuit.

7. The system of claim 1 wherein said switch matrix is capable of removing any underperforming cell(s) from service.

8. The system of claim 1 wherein said controller may be field programmed.

9. The system of claim 1 wherein said controller contains an algorithm to optimize the state of the system based on prevailing conditions.

10. The system of claim 9 wherein said prevailing conditions include at least the geographical location of said system and said system further contains a means of determining its geographical location.

11. The system of claim 10 wherein said means of determining location is selected from the following group: satellite-based GPS systems; and cellular tower-based location systems.

12. A method for managing batteries comprising:
configuring a system including at least one power-consuming device, at least one battery charging device, and an array of said batteries with a switch matrix capable of providing management at the individual cell level using battery characteristics reported by a fuel gauge, said switch matrix further capable of combining cells dynamically in selected series and parallel arrangements;
measuring each battery's impedance as a proxy for real, usable energy density and availability; and,
controlling said switch matrix using a controller, said controller including a learning algorithm to selectively draw, store, charge, manage, and recharge each cell in said battery array individually.

13. The method of claim 12 further comprising the step of:
determining the geographical location of said system and providing said location data as input to said controller, so that power management and control decisions may be varied based on location.

14. The method of claim 12 further comprising the step of:
identifying any defective batteries in said array, based on said impedance measurement, and isolating said defective batteries from said charger and said power consuming device.
